(19) United States
(12) Patent Application Publication
(10) Pub. No.: US 2005/0166432 A1
(43) Pub. Date: Aug. 4, 2005

(54) Sign assembly

(76) Inventor: Stephen J. Garske, Little Canada, MN (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/771,128

(22) Filed: Feb. 3, 2004

(51) Int. Cl. G09F 15/02

(52) U.S. Cl. 40/607.05

(57) ABSTRACT

A sign assembly includes a main sign portion and a pair of legs extending from a bottom surface of the main sign portion. The pair of legs are formed of a single curved, elongate member embedded within the main sign portion.

### FIELD

This invention relates to the field of signs, and more specifically to sign for a golf course.

### BACKGROUND

Signs for golf courses are typically mounted to the ground and include words or symbols to direct players in the right direction around the golf course or as yardage markers, for example. The signs are sometimes moved around from place to place and can be exposed to all types of weather. What is needed is a more durable sign assembly.

### SUMMARY

In one aspect of the inventive subject matter disclosed herein, a highly durable sign assembly is provided. The sign assembly includes a main sign portion and a pair of legs extending from a bottom surface of the main sign portion. The pair of legs are formed of a single curved, elongate member having a curved portion embedded within the main sign portion.

### BRIEF DESCRIPTION OF THE DRAWINGS

FIG. 1 shows a perspective view of a sign assembly according to one embodiment of the inventive subject matter disclosed herein.

FIG. 2 shows a bottom view of the sign assembly of FIG. 1.

FIG. 3 shows another perspective view of the sign assembly of FIG. 1.

### DETAILED DESCRIPTION

The following detailed description and accompanying drawings show various embodiments according to the inventive subject matter disclosed herein. These embodiments are described in sufficient detail to enable those skilled in the art to practice the invention. Other embodiments may be utilized and structural changes may be made without departing from the scope of the present invention.

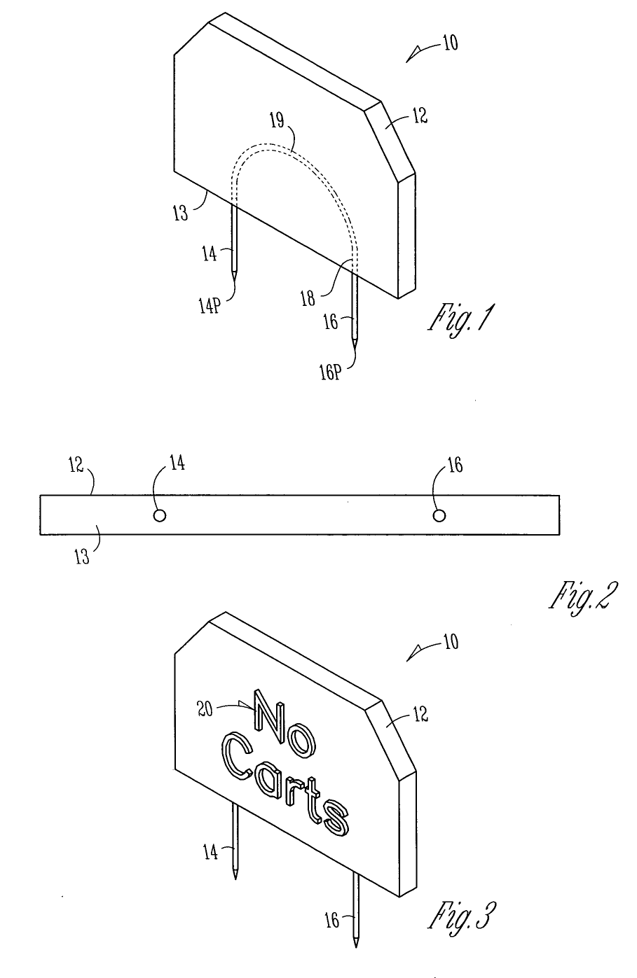

FIGS. 1 and 2 shows a sign assembly 10 according to one embodiment of the inventive subject matter disclosed herein. FIG. 1 is a perspective view of the sign assembly and FIG. 2 is a bottom view. Sign assembly 10 includes a main sign portion 12 and a pair of legs 14 and 16 extending from a bottom surface 13 of the main sign portion 12.

The pair of legs 14, 16 are formed a single, curved, elongate member 18 embedded within the main sign portion 12. Member 18 can be a rod that is curved or bent to be U-shaped, V-shaped, square-end-shaped, or other unitary shape such that the two legs 14 and 16 are substantially parallel and have approximately the same length. A curved portion 19 of the elongate member 18 is embedded within sign portion 12 with legs 14 and 16 extending from the sign. In one embodiment, each of the legs includes a sharpened or pointed tip 14P, 16P to help insert the sign assembly into the ground. The unitary design of member 18, which is molded directly into the main sign portion 12, keeps the legs 14, 16 from loosening and falling out of the main sign portion 12. The curved elongate member 18 can be a ¼″ diameter stainless steel rod, for example.

In one embodiment, the main sign portion 12 is formed of a molded polymer, such as a dense rubber. The polymer can be a flexible, pliable polymer material such that sign portion 12 is extremely durable and able to withstand golf balls bouncing off the sign, cold and hot weather, and repeated use without cracking like a plastic sign, for example. In one embodiment, the sign can be about ½″ thick. Some embodiments can be from about ¼″ thick to 1″ thick or more. In one example, the main sign portion 12 has dimensions of about 12″×6″. The sign portion 12 material and the unitary leg design provide an extremely durable sign that can be pulled out of the ground and reinserted and used over and over without any damage.

FIG. 3 shows further details of sign assembly 10 according to one embodiment. Sign assembly 10 includes three-dimensional, raised symbols 20 formed on a front surface of the sign. The raised symbols 20 can include arrows or other symbols or lettering. The raised lettering can include words to direct golf carts around a golf course, such as “No Carts”, “Carts to the Left”, “Carts to the Right”, and so on. The signs can also include yardage indicators or include directions to other locations on a golf course. Again, the highly durable signs herein can be pulled out of the ground and reused at different locations repeatedly without breaking down or having the legs fall out. This allows a golf course superintendent to move the sign around a course as needed. The sign is pushed into the ground with legs 14 and 16 pushed into the ground and supporting main sign portion 12.

Raised symbols 20 can be molded directly with the main sign portion 12 and formed at the same time as the rest of the sign is formed in the mold. One embodiment utilizes a different color polymer for the raised symbol portion to provide a contrast and easier to see symbols. For instance, the raised symbols 20 can be white while the main portion 12 is black, green or blue. Again, the raised symbols can be molded directly with the main sign portion. This feature eliminates using glued-on or screwed-on letters which can easily fall off or break off of signs. The integral, raised symbols 20 of sign assembly 10 provide for a highly durable, easily readable sign.

One method of forming a sign assembly 10 is to provide an elongate rod, such as a stainless steel rod, curved or bent such that the rod is U-shaped, V-shaped, or square-ended, with the two legs being about equal in length. The bent rod is placed in a mold and then a polymer material is poured in the mold and the curved portion of the elongate rod is embedded in the polymer material with the pair of legs extending from the material. As noted, the mold can include raised portions to form raised, three-dimensional symbols on the sign at the same time the main body of the sign is being formed.

As noted above, a sign assembly according to the present subject matter is nearly unbreakable. The lettering of the sign can be three-dimensional raised symbols and be molded right into the base material. Additionally, the legs are formed of a unitary rod such that the sign would have to be virtually destroyed for the legs to detach. The flexible, pliable, and durable polymer material of the sign body and the continuous leg design produces a sign assembly more durable than anything else in the field. The unitary leg design embedded into the dense, yet flexible polymer sign body minimizes if not eliminates the possible detachment of the legs from the sign body.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A sign assembly comprising:
a main sign portion; and
a pair of legs extending from a bottom surface of the main sign portion, the pair of legs being formed of a single, curved, elongate member having a curved portion embedded within the main sign portion.

2. The sign assembly of claim 1, wherein the main sign portion includes raised symbols.

3. The sign assembly of claim 2, wherein the raised symbols are integrally formed with the main sign portion.

4. The sign assembly of claim 2, wherein the raised symbols include directions for carts to travel on a golf course.

5. The sign assembly of claim 1, wherein the main sign portion is a polymer material.

6. The sign assembly of claim 1, wherein the single, curved elongate member is a stainless steel rod.

7. A sign assembly comprising:
a main sign portion formed of a molded polymer and having raised symbols; and
a pair of legs extending from a bottom surface of the main sign portion, wherein the pair of legs are formed of a single, curved, elongate rod embedded in the main sign portion.

8. The sign assembly of claim 7, wherein the pair of legs include pointed tips.

9. The sign assembly of claim 7, wherein the raised symbols are integrally molded with the main sign portion.

10. The sign assembly of claim 7, wherein the elongate rod includes a U-shape.

11. A method comprising:
bending an elongated rod so that the rod includes a bent portion and defines a pair of legs of approximately the same length; and
molding a polymer around the bent portion so that the bent portion is embedded in the polymer with the legs extending from the polymer, the polymer being molded to form a sign.

12. The method of claim 11, wherein bending the rod includes bending the rod into a U-shape.

13. The method of claim 11, wherein bending the rod includes bending a stainless steel rod.

14. The method of claim 11, wherein molding the polymer includes molding the polymer with raised symbols on a surface of the polymer.

15. The method of claim 14, wherein the raised symbols include directions for golf carts to travel on a golf course.
